(19) United States
(12) Patent Application Publication
(10) Pub. No.: US 2010/0121749 A1
(43) Pub. Date: May 13, 2010

(54) REAL-TIME VALIDATION SYSTEM FOR TRANSACTIONS

(75) Inventors: Athellina Athsani, San Jose, CA (US); Jonathan Matkowsky, Palo Alto, CA (US); Chris Kalaboukis, Los Gatos, CA (US)

Correspondence Address: YAHOO! INC.;c/o DUANE MORRIS LLP, Attn.: IP Docketing, 30 SOUTH 17TH STREET, Philadelphia, PA, 19103-4196, US

(73) Assignee: YAHOO! INC., Sunnyvale, CA (US)

(21) Appl. No.: 12/268,943

(22) Filed: Nov. 11, 2008

(51) Int. Cl. G06Q 40/00

(52) U.S. Cl. 705/35

(57) ABSTRACT

A method of validating a transaction between a giving entity and a receiving entity includes: providing receiving-entity context values to the receiving entity for evaluating requests by the receiving entity; accepting request values for the receiving entity, wherein the request values include values for at least one of goods, services or currency; determining a receiving-entity request item in a database from the request values and the receiving-entity context values, wherein the database is stored in a computer-readable medium; providing giving-entity context values to the giving entity for evaluating offers by the giving entity; accepting offer values for the giving entity, wherein the offer values include values for at least one of goods, services or currency; determining a giving-entity offer item in the database from the offer values and the giving-entity context values; and determining transaction conditions in the database from the receiving-entity request item and the giving-entity offer item, wherein the transaction conditions include at least one giving-entity action for performance by the giving entity, at least one receiving-entity action for performance by the receiving entity, and at least one verification action for the transaction.

### BACKGROUND OF THE INVENTION

1. Field of Invention

The present invention relates to computer systems generally and more particularly to systems that support transactions between system users or system elements.

2. Description of Related Art

Entities engage in a variety of transactions involving goods, services and currency. In some contexts a buyer directly pays currency in the form of cash to a seller of goods and receives the goods from the seller, thereby completing the transaction. Often the reasonableness of the conditions for the transfer between a buyer and seller are clear and unquestioned from the context (e.g., a marketplace where values and reputations are clear). In other contexts, the connections are more indirect and the conditions for transfer between the parties is not as clear or reliable. Computers systems, possibly including Internet connectivity, provide additional possibilities for effecting transactions that otherwise would not come about due to various uncertainties involving the transactions (e.g., reasonable price or exchange for goods and services, reputation of parties, supervision of process, etc.).

For example, in the context specifically of charitable giving, related systems have been developed. See, for example U.S. Pat. Nos. 5,555,497 and 6,519,573, which are incorporated herein by reference in their entirety. Also, systems have been developed in the context of peer to-peer lending. See, for example, “Options Grow for Investors to Lend Online,” Wall Street Journal, Jul. 18, 2007. However, general systems for supporting and validating transactions (e.g., for exchanging goods, services or currency) are generally unavailable.

Thus there is a need for improved systems and methods for providing transactional support.

### SUMMARY OF THE INVENTION

In one embodiment of the present invention, a method of validating a transaction between a giving entity and a receiving entity includes: providing receiving-entity context values to the receiving entity for evaluating requests by the receiving entity; accepting request values for the receiving entity, wherein the request values include values for at least one of goods, services or currency; determining a receiving-entity request item in a database from the request values and the receiving-entity context values, wherein the database is stored in a computer-readable medium; providing giving-entity context values to the giving entity for evaluating offers by the giving entity; accepting offer values for the giving entity, wherein the offer values include values for at least one of goods, services or currency; determining a giving-entity offer item in the database from the offer values and the giving-entity context values; and determining transaction conditions in the database from the receiving-entity request item and the giving-entity offer item, wherein the transaction conditions include at least one giving-entity action for performance by the giving entity, at least one receiving-entity action for performance by the receiving entity, and at least one verification action for the transaction. One or more values for the transaction can be saved in a computer-readable medium (e.g., values for the transaction conditions can be saved directly or through some related characterization).

According to one aspect of this embodiment, the receiving-entity context values may include demographic values that characterize similar requests within a demographic group, and accepting the request values may include evaluating the request values for consistency with the receiving-entity context values.

According to another aspect, the request values may include at least one incentive value that relates some benefit (e.g., goods, services, currency) to a temporal condition of performing some giving entity action. For example, the giving entity may receive a cash rebate if the giving-entity action is performed by a certain time.

According to another aspect, determining the receiving-entity request item may include enforcing a consistency condition that relates the request values to the receiving-entity context values.

According to another aspect, the giving-entity context values may include demographic values that characterize similar offers within a demographic group, and accepting the offer values may include evaluating the offer values for consistency with the giving-entity context values.

According to another aspect, determining the giving-entity request item may include enforcing a consistency condition that relates the offer values to the giving-entity context values.

According to another aspect, the transaction conditions may include a sequence of giving-entity actions and a sequence of receiving-entity actions so that pairs of giving-entity actions are separated by at least one receiving-entity action.

According to another aspect, the transaction conditions may include a sequence of receiving-entity actions and a sequence of verification actions so each receiving-entity action is verified by a corresponding verification action.

According to another aspect, the at least one giving-entity action includes a first giving-entity action, the at least one receiving-entity action includes a first receiving-entity action, and the at least one verification action a first verification action, and the method may further include: performing the first verification action after the performance of the first giving-entity action and the first receiving-entity action by accessing a network that provides real-time values for the first giving-entity action and the first receiving-entity action.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer.

In these ways the present invention enables improved systems and methods for providing transactional support.

### BRIEF DESCRIPTION OF THE DRAWINGS

FIG. 1 shows a validation system together with a Receiving Entity (RE) and a Giving Entity (GE) in accordance with certain embodiments of the present invention as described herein.

FIG. 2 shows a method for validating transactions between the RE and the GE for an embodiment of the present invention.

FIG. 3 shows an exemplary method for performing the transaction conditions sequentially in accordance with the embodiment shown in FIG. 2.

FIG. 4 shows a conventional general-purpose computer.

FIG. 5 shows a conventional Internet network configuration.

### DETAILED DESCRIPTION OF EXEMPLARY EMBODIMENTS

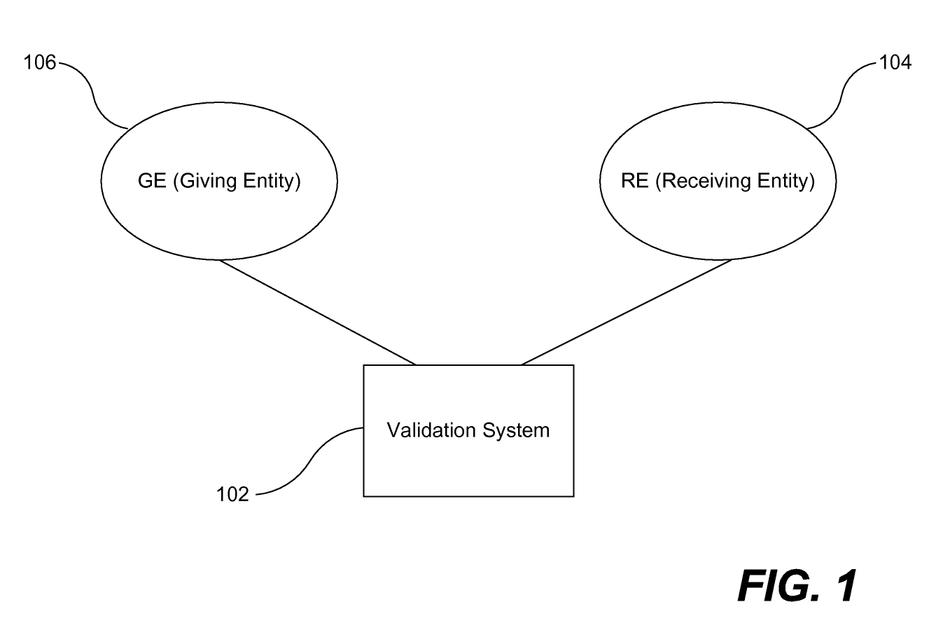

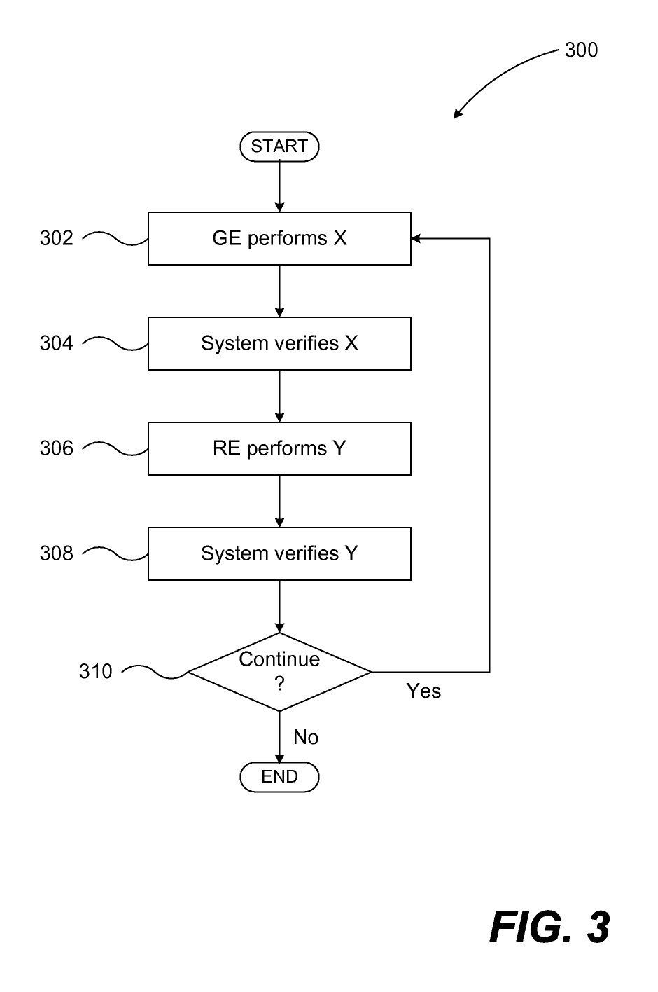

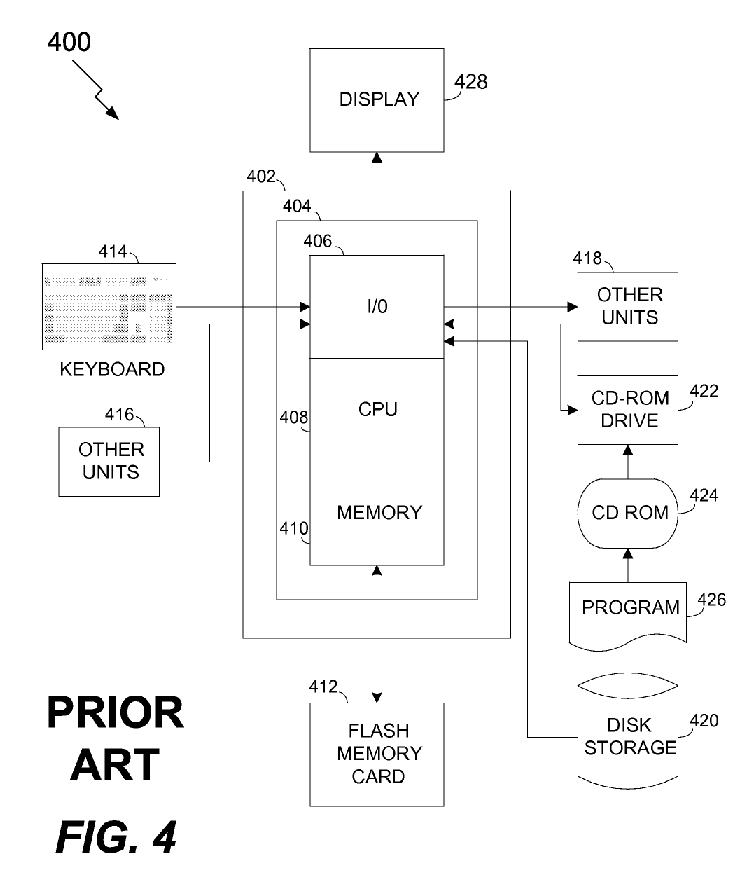

FIG. 1 shows a validation system 102 together with a Receiving Entity (RE) 104 and a Giving Entity (GE) 106 in accordance with certain embodiments of the present invention as described herein. For example, the RE 104 may wish to receive some combination of goods, services and currency and the GE 106 may offer to fulfill that wish in exchange for a reciprocal combination of goods, services and currency. General exchanges (e.g., bartering) of goods, services and currency may be considered in this context, where currency includes all forms of currency including without limitation, cash and credits, electronic and paper. These combinations of goods, services and currency may include temporal conditions (e.g., performance of a service within a time period), and spatial conditions (e.g., performance of a service by a provider in some area). Additional conditions may include incentives that relate combinations of goods, service, and currency to some performance condition (e.g., a cash rebate or equivalent benefit if performance is within a specified time and budget.). The system 102 may include a conventional computer as described below (e.g., in FIG. 3), and similarly the RE 104 and GE 106 may employ conventional computers. The connections between the system 102, RE 104, and GE 106 may be conventional Internet or other network connections as discussed below (e.g., in FIG. 4).

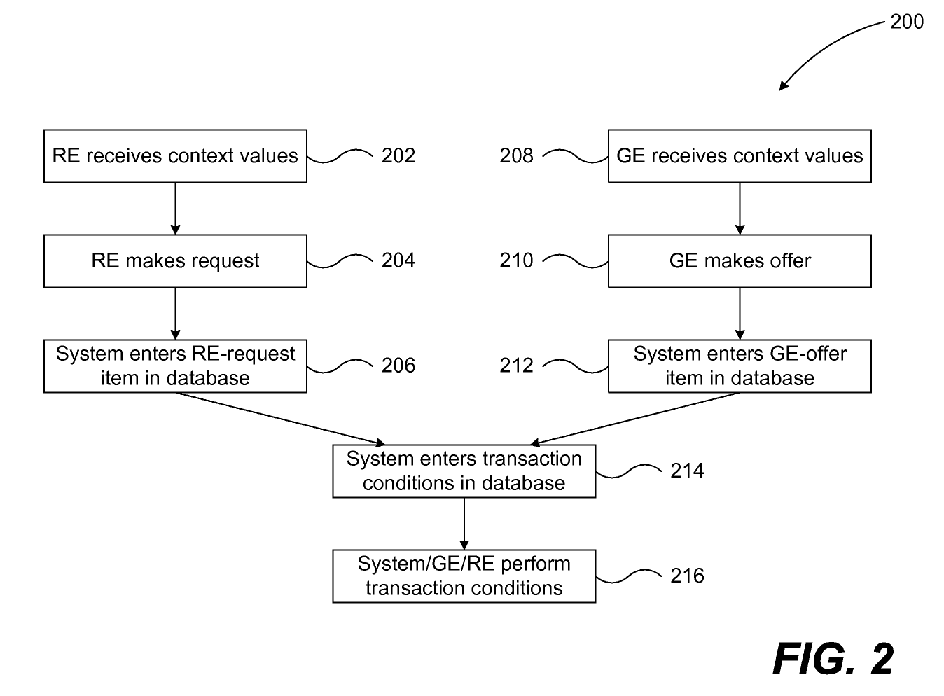

FIG. 2 shows an exemplary method 200 as implemented by the system 102 for validating transactions between the RE 104 and the GE 106 with two parallel tracks. In one track the RE enters the system and receives context values for evaluating RE requests 202. The RE makes a request (e.g., for goods, services or currency) 204 and the system enters a RE request item in a database (e.g., stored in the system in a computer-readable medium) 206. In another track, the GE enters the system and receives context values for evaluating GE offers 208. The GE makes an offer (e.g., for goods, services or currency) 210 and the system enters a GE-offer item in the database 212. Depending on the circumstances and the operational setting, the ordering of some elements may be changed. For example the RE may make a request 204 and then receive context values 202, and similarly the GE may make an offer 210 and then receive context values 208.

Then the system 102 combines or integrates the RE request and the GE offer to provide transaction conditions in the database 214. These transaction conditions may include at least one giving-entity action for performance by the giving entity, at least one receiving-entity action for performance by the receiving entity, and at least one verification action for the transaction for performance by the system (e.g., in a supervisory role). Subsequently, the system, GE and RE can perform or carry out these conditions 216.

The context values for the RE and the GE 202, 208 may include demographic values that characterize similar requests within a demographic group. The demographic values may include spatial, temporal, topical, social data that relates to the RE or the GE or their affiliated groups. The level of detail for these values can be specified by the users (e.g., GE, RE) or an administrator of the system. These values may be used in formation of the request by the RE 204 and the offer by the GE 210 (e.g., as a requirement or suggestion for demographic consistency) or may be enforced by the system (e.g., for demographic consistency) when the system generates transaction conditions 214.

Additionally the context values for the RE and the GE 202, 208 may include profile information specific to the parties in the transaction, so that some GE context values relate specifically to the RE and some RE context values relate specifically to the GE. The profile information for the RE and the GE may include values for credit, financial accounts, occupation, education, criminal records, tax ID, social security no., and reputation. For example, the system may enable the GE to view certain information on the RE entered by RE, system users or by system-gathered contextual information on the RE. Similarly the system may enable the RE to view certain information on the GE entered by GE, system users or by system-gathered contextual information on the GE. These context values may be provided to support the initial RE request 204 and the GE offer 210 or as part of the formation of transaction conditions 214 that require formal approval from the RE and the GE.

These context values may include results from automated contextual-information gathering processes that collect relevant information related to the RE and GE including entity specific information (e.g., user profile data for credit history, reputation), locations and times for performance conditions, relevant demographic groups (e.g., based on spatial/temporal relationships or some affiliation), and information entered by other system users. As a result, the system may enable the GE to select a suitable RE from a larger pool of candidates within a demographic group (e.g., from a geographically based interface or automatic alerts via Internet or phone). The system may enable the GE to assess in real time the extent to which his or her intent matches the substantive nature of the RE requests, the economic viability of the RE (via system ranking), and the true cost or value of the RE requests. The system may enable the GE to make a set of conditions or select a set of system-generated conditions for RE to meet prior to the request fulfillment.

Similarly, the system may enable the RE to select a suitable GE from a larger pool of candidates within a demographic group (e.g., from a geographically based interface or automatic alerts via Internet or phone). The system may enable the RE to assess in real time the value or cost of the request, and the economic viability of the GE (via system ranking). The system may enable the RE to develop a set of conditions or select a set of system-generated conditions for the GE to meet prior to the request fulfillment. The system may enable the RE to rank or rate features of its request.

The system may assign values and rankings for the RE (e.g., for request and reputation), the GE (e.g., for offer and reputation), and the components of the transaction conditions (e.g., fulfillment conditions for RE and GE).

The transaction conditions 214 may involve sequences of actions for the system, RE and GE, possibly with temporal restriction (e.g., a certain RE action must occur within a certain time of a certain GE action or at a certain frequency). Pairs of GE actions may be separated by at least one RE action (e.g., the GE provides cash in stages and the RE provides corresponding progress reports), and each RE action may be followed by a corresponding verification action that is performed by the system (e.g., the system logs or verifies details of an RE progress report). As discussed above the formation of the transaction conditions may be include providing additional contextual information to the RE and GE and may require formal agreement between the RE and the GE as part of the finalization of the transaction conditions.

Depending on the requirements of the operational setting, performance of the contract conditions 216 can be facilitated by network connectivity that enables real time operations. As a result the initial RE request 204 and GE offer 210 can be made in real time. Additionally, the performance of the transaction conditions 216 can be made in real time including transmitting goods, services or currency from the GE to the RE.

FIG. 3 shows an exemplary method 300 for performing the transaction conditions sequentially 216 with system verifications for both GE actions and RE actions. First, the GE performs X (GE action) 302, next the system verifies X 304, next the RE performs Y (RE action) 308, and then the system verifies Y 308. A test can be made 310 to determine if the process ends or continues with additional GE actions 302.

At least some values for the results of the method 200 can be output to a user or saved for subsequent use. For example the transaction conditions can be saved directly for application as in transaction management Alternatively, some derivative or summary form of the results can be saved for later use according to the requirements of the operational setting.

As a specific example, if the RE is a disaster victim (e.g., Hurricane Katrina) who wants to rebuild a home that was destroyed, the relevant contextual information may include personal information about the RE (e.g., credit history, educational history, job history, criminal records) as well as relevant demographics including residential construction costs in relevant area (e.g., within 50 miles of New Orleans).

As another specific example, the GE may be a charitable organization that wants to support a RE that will operate a school where there will be recurring expenses for salaries and teaching supplies. The GE actions may include financial support at regular intervals (e.g., quarterly, annually), the RE actions may include progress reports that include attendance records and test scores, and the verification actions may include verifying the progress reports through public records or private investigations or evaluating the school performance by comparing attendance records and test scores with comparable demographic groups.

The specific details of an operational setting can influence how easily information is integrated into the system as well as the timing of the actions (e.g., for real-time or near-real-time operation). For example, a “W4 Communications Network” or W4 network, provides information related to the “Who, What, When and Where” of interactions within the network. See, for example, U.S. patent application Ser. No. 12/182,813 (“System and Method for Context Enhanced Mapping,” filed Jul. 30, 2008), which is incorporated herein by reference in its entirety.

In some cases, a W4 network is a collection of users, devices and processes that foster both synchronous and asynchronous communications between users and their proxies providing an instrumented network of sensors providing data recognition and collection in real-world environments about any subject, location, user or combination thereof. The network may handle the routing/addressing, scheduling, filtering, prioritization, replying, forwarding, storing, deleting, privacy, transacting, triggering of a new message, propagating changes, transcoding and linking. Furthermore, these actions may be performed on any communication channel accessible by the network. The network may use a data modeling strategy for creating profiles for not only users and locations, but also for any device on the network and any kind of user-defined data with user-specified conditions. Using social, spatial, temporal and logical data available about a specific user, topic or logical data object, every entity known to the network can be mapped and represented against all other known entities and data objects in order to create both a micro graph for every entity as well as a global graph that relates all known entities with one another. These relationships between entities and data objects can be stored in a global index within the network.

With the benefit of a W4 network (or similar technology), real-time operations are enabled for embodiments of the present invention. For example, in the case described above where the GE wants to support a RE that will operate a school, real-time verification of the educational mission is possible. If the GE had requested proof that the RE is teaching twenty (20) students at a given time, in a given location and given frequency, then through the W4 technology the system is capable of gathering the unique ID of individual students via their mobile devices to verify that they are at the given location (GPS coordinates) at the given frequency and time.

As another example of real-time validation, consider the case where the RE is Susan, whose son is struck by a car. When Susan is at the accident site and makes a request for an ambulance to take her son to a hospital, the W4-enhanced system is capable of making a real-time validation by gathering information for the location of Susan and her son from their mobile devices (e.g., GPS location and time stamps). The system can further track her son's location after ambulance pickup and transfer to the hospital based on data from his mobile device.

Additional embodiments relate to an apparatus for carrying out any one of the above-described methods, where the apparatus includes a computer for executing computer instructions related to the method. In this context, the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet. At least some values for the results of the method can be saved, either in memory (e.g., RAM (Random Access Memory)) or permanent storage (e.g., a hard-disk system) for later use.

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

As described above, certain embodiments of the present invention can be implemented using standard computers and networks, including the Internet. FIG. 4 shows a conventional general purpose computer 400 with a number of standard components. The main system 402 includes a motherboard 404 having an input/output (I/O) section 406, one or more central processing units (CPU) 408, and a memory section 410, which may have a flash memory card 412 related to it. The I/O section 406 is connected to a display 428, a keyboard 414, other similar general-purpose computer units 416, 418, a disk storage unit 420 and a CD-ROM drive unit 422. The CD-ROM drive unit 422 can read a CD-ROM medium 424 which typically contains programs 426 and other data.

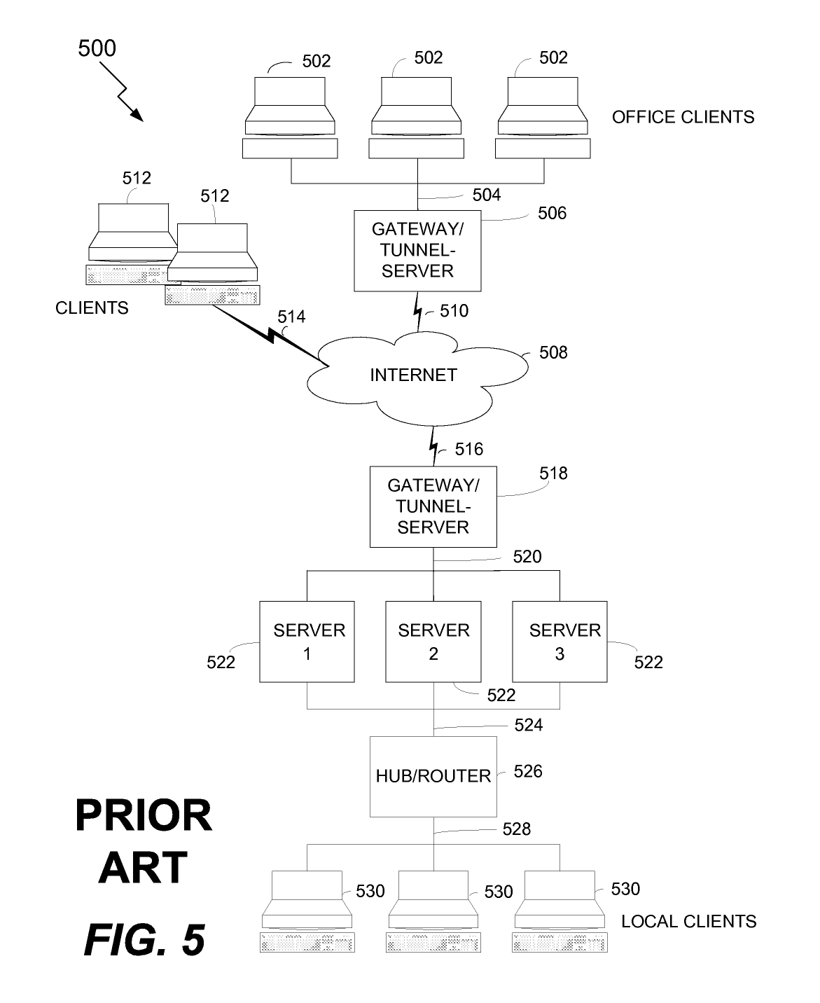

FIG. 5 shows a conventional Internet network configuration 500, where a number of office client machines 502, possibly in a branch office of an enterprise, are shown connected 504 to a gateway/tunnel-server 506, which is itself connected to the Internet 508 via some internet service provider (ISP) connection 510. Also shown are other possible clients 512 similarly connected to the Internet 508 via an ISP connection 514. An additional client configuration is shown for local clients 530 (e.g., in a home office). An ISP connection 516 connects the Internet 508 to a gateway/tunnel-server 518 that is connected 520 to various enterprise application servers 522. These servers 522 are connected 524 to a hub/router 526 that is connected 528 to various local clients 530.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

1. A method of validating a transaction between a giving entity and a receiving entity, comprising:
providing receiving-entity context values to the receiving entity for evaluating requests by the receiving entity;
accepting request values for the receiving entity, wherein the request values include values for at least one of goods, services or currency;
determining a receiving-entity request item in a database from the request values and the receiving-entity context values, wherein the database is stored in a computer-readable medium;
providing giving-entity context values to the giving entity for evaluating offers by the giving entity;
accepting offer values for the giving entity, wherein the offer values include values for at least one of goods, services or currency;
determining a giving-entity offer item in the database from the offer values and the giving-entity context values; and
using a computer for determining transaction conditions in the database from the receiving-entity request item and the giving-entity offer item, wherein the transaction conditions include at least one giving-entity action for performance by the giving entity, at least one receiving-entity action for performance by the receiving entity, and at least one verification action for the transaction.

2. A method according to claim 1, wherein
the receiving-entity context values include demographic values that characterize similar requests within a demographic group, and
accepting the request values includes evaluating the request values for consistency with the receiving-entity context values.

3. A method according to claim 1, wherein the request values include at least one incentive value that relates some benefit to a temporal condition of performing some giving-entity action.

4. A method according to claim 1, wherein determining the receiving-entity request item includes enforcing a consistency condition that relates the request values to the receiving-entity context values.

5. A method according to claim 1, wherein
the giving-entity context values include demographic values that characterize similar offers within a demographic group, and
accepting the offer values includes evaluating the offer values for consistency with the giving-entity context values.

6. A method according to claim 1, wherein determining the giving-entity request item includes enforcing a consistency condition that relates the offer values to the giving-entity context values.

7. A method according to claim 1, wherein the transaction conditions include a sequence of giving-entity actions and a sequence of receiving-entity actions so that pairs of giving-entity actions are separated by at least one receiving-entity action.

8. A method according to claim 1, wherein the transaction conditions include a sequence of receiving-entity actions and a sequence of verification actions so each receiving-entity action is verified by a corresponding verification action.

9. A method according to claim 1, wherein the at least one giving-entity action includes a first giving-entity action, the at least one receiving-entity action includes a first receiving-entity action, and the at least one verification action a first verification action, and the method further comprises:
performing the first verification action after the performance of the first giving-entity action and the first receiving-entity action by accessing a network that provides real-time values for the first giving-entity action and the first receiving-entity action.

10. An apparatus for validating a transaction between a giving entity and a receiving entity, the apparatus comprising a computer for executing computer instructions, wherein the computer includes computer instructions for:
providing receiving-entity context values to the receiving entity for evaluating requests by the receiving entity;
accepting request values for the receiving entity, wherein the request values include values for at least one of goods, services or currency;
determining a receiving-entity request item in a database from the request values and the receiving-entity context values, wherein the database is stored in a computer-readable medium;
providing giving-entity context values to the giving entity for evaluating offers by the giving entity;
accepting offer values for the giving entity, wherein the offer values include values for at least one of goods, services or currency;
determining a giving-entity offer item in the database from the offer values and the giving-entity context values; and
determining transaction conditions in the database from the receiving-entity request item and the giving-entity offer item, wherein the transaction conditions include at least one giving-entity action for performance by the giving entity, at least one receiving-entity action for performance by the receiving entity, and at least one verification action for the transaction.

11. An apparatus according to claim 10, wherein the computer includes a processor with memory for executing at least some of the computer instructions.

12. An apparatus according to claim 10, wherein the computer includes circuitry for executing at least some of the computer instructions.

13. An apparatus according to claim 10, wherein determining the receiving-entity request item includes enforcing a consistency condition that relates the request values to the receiving-entity context values.

14. An apparatus according to claim 10, wherein determining the giving-entity request item includes enforcing a consistency condition that relates the offer values to the giving-entity context values.

15. An apparatus according to claim 10, wherein the at least one giving-entity action includes a first giving-entity action, the at least one receiving-entity action includes a first receiving-entity action, and the at least one verification action a first verification action, and the computer further includes computer instructions for:
performing the first verification action after the performance of the first giving-entity action and the first receiving-entity action by accessing a network that provides real-time values for the first giving-entity action and the first receiving-entity action.

16. A computer-readable medium that stores a computer program for validating a transaction between a giving entity and a receiving entity, wherein the computer program includes instructions for:
providing receiving-entity context values to the receiving entity for evaluating requests by the receiving entity;
accepting request values for the receiving entity, wherein the request values include values for at least one of goods, services or currency;
determining a receiving-entity request item in a database from the request values and the receiving-entity context values, wherein the database is stored in a computer-readable medium;
providing giving-entity context values to the giving entity for evaluating offers by the giving entity;
accepting offer values for the giving entity, wherein the offer values include values for at least one of goods, services or currency;
determining a giving-entity offer item in the database from the offer values and the giving-entity context values; and
determining transaction conditions in the database from the receiving-entity request item and the giving-entity offer item, wherein the transaction conditions include at least one giving-entity action for performance by the giving entity, at least one receiving-entity action for performance by the receiving entity, and at least one verification action for the transaction.

17. A computer-readable medium according to claim 16, wherein
the receiving-entity context values include demographic values that characterize similar requests within a demographic group, and
accepting the request values includes evaluating the request values for consistency with the receiving-entity context values.

18. A computer-readable medium according to claim 16, wherein the request values include at least one incentive value that relates some benefit to a temporal condition of performing some giving-entity action.

19. A computer-readable medium according to claim 16, wherein
the giving-entity context values include demographic values that characterize similar offers within a demographic group, and
accepting the offer values includes evaluating the offer values for consistency with the giving-entity context values.

20. A computer-readable medium according to claim 16, wherein the transaction conditions include a sequence of receiving-entity actions and a sequence of verification actions so each receiving-entity action is verified by a corresponding verification action.

21. A method according to claim 1, wherein
the at least one giving-entity action includes an element of goods, services or currency for performance by the giving entity and provides a benefit to an entity other than the giving entity, and
the at least one receiving-entity action includes an element of goods, services or currency for performance by the receiving entity and provides a benefit to an entity other than the receiving entity.

22. A method according to claim 1, wherein
the at least one giving-entity action includes providing currency or goods to the receiving entity; and
the at least one receiving-entity action includes providing a service that benefits a service-benefiting entity other than the receiving entity or the giving entity, and providing a corresponding progress report on the provided service.

23. A method according to claim 1, wherein
the transaction conditions include a sequence of giving-entity actions and a sequence of receiving-entity actions so that pairs of giving-entity actions are separated by at least one receiving-entity action,
each giving-entity action includes an element of goods, services or currency for performance by the giving entity and provides a benefit to an entity other than the giving entity, and
each receiving-entity action includes an element of goods, services or currency for performance by the receiving entity and provides a benefit to an entity other than the receiving entity.

24. A method according to claim 1, wherein
the transaction conditions include a sequence of receiving-entity actions and a sequence of verification actions so that each receiving-entity action is verified by a corresponding verification action, and
each receiving-entity action includes an element of goods, services or currency for performance by the receiving entity and provides a benefit to an entity other than the receiving entity.
